(19) United States
(12) Patent Application Publication
(10) Pub. No.: US 2016/0307409 A1
(43) Pub. Date: Oct. 20, 2016

(54) Method of Managing a Card Game Through Player Terminals

(71) Applicant: Michael R Aboumrad, SR., Reno, NV (US)

(72) Inventor: Michael R Aboumrad, SR., Reno, NV (US)

(21) Appl. No.: 15/194,292

(22) Filed: Jun. 27, 2016

Related U.S. Application Data
(63) Continuation-in-part of application No. 14/726,361, filed on May 29, 2015.
(60) Provisional application No. 62/004,478, filed on May 29, 2014.

(51) Int. Cl. G07F 17/32

(52) U.S. Cl. CPC G07F 17/3244; G07F 17/3288; G07F 17/3293

(57) ABSTRACT

A method of managing a card game through player terminals allows players to play a virtual card game. To perform the method, an electronic game table is provided and includes a plurality of player terminals. A computing unit of the electronic game table manages a virtual deck and a dealer profile. To begin the game, a monetary ante is received from at least one active terminal. Three initial cards are dealt to each of the active terminals and the dealer profile. Active terminals may submit a playing bet request to continue playing or submit a fold request. Then, each of the active terminals and the dealer profile are allocated two additional cards. The corresponding player hand for each active terminal is compared to the dealer hand for the dealer profile. If a corresponding player hand ranks higher than the dealer hand, a monetary payout is awarded to the winning terminal.

The current application is a continuation-in-part (CIP) application of a U.S. non-provisional application Ser. No. 14/726,361 filed on May 29, 2015. The U.S. non-provisional application Ser. No. 14/726,361 claims a priority to a U.S. provisional application Ser. No. 62/004,478 filed on May 29, 2014.

### FIELD OF THE INVENTION

The present invention relates generally to methods for managing and playing card games. More specifically, the present invention is a method of managing a poker game with an electronic game table that utilizes a virtual deck comprising eight Ace cards, eight King cards, eight Queen cards, eight Jack cards, and eight 10 cards from two standard 52-card decks, otherwise known as French decks. Two Joker cards are included in the deck for a total of 42 cards in the deck, although a maximum of 40 cards of the virtual deck are dealt during each session of play. Players interact with the electronic game table through a plurality of player terminals.

### BACKGROUND OF THE INVENTION

Poker is by far one of the most popular gambling card games due to the combination of skill and chance that is required for success. Poker has a number of different variants with Texas Hold 'Em in particular having developed a large professional scene. The object of poker for each player is to assemble the strongest possible hand utilizing individually dealt cards as well as cards in the “community” that are shared and may be used by all players. Forced bets or “blinds” are generally required in order to be dealt a hand and to provide an initial stake in play. The position of the blinds as well as position of the (house or nominal) dealer rotates with the progression of play from hand to hand. After each player has been dealt a hand, one or more betting rounds take place in which players are able to place wagers into a pot. Although the rules differ across variants of poker, cards in hands are generally discarded and replaced or supplemented with additional cards from the deck between betting rounds. Wagering is largely centered on bluffing in which a player attempts to lure other players into calling his or her bets or folding their hands. After the conclusion of all betting rounds, players remaining in play are required to display their hands in order to determine the player with the highest ranking hand. While there are many variations of poker, the same hand ranking system is generally used across the various different types of poker. One notable disadvantage of conventional poker games is very low rates of royal flushes.

The present invention is a method of managing a card game through virtual terminals. In the preferred embodiment of the present invention, the card game utilizes a 42-card virtual deck comprising eight Ace cards, eight King cards, eight Queen cards, eight Jack cards, eight 10 cards, and two Joker cards. The two Joker cards serve as bugs and may be utilized in an attempt to attain the highest possible five card hand. The virtual deck is managed by a computing unit of an electronic game table. Although the deck comprises 42 cards, only a maximum of 40 cards are utilized for play. The poker game may be played by up to seven players and one dealer. Prior to receiving a hand, each player is required to post a monetary ante through a player terminal of the electronic game table. Players may also post an optional bonus side bet. Each player is dealt three initial cards through a player terminal. Players are then permitted to view their initial three card hands and hold their bets, double their antes, or fold their hands. Two additional cards are then dealt to each player. After the players receive their cards, their hands are compared with the dealer hand to identify winning terminals. Regardless of hand ranking outcome, a player will receive ante win if the players hand outranks the dealer's hand. Players must beat the dealer's hand in order to win the main game and payouts are determined by the ranks of the players' hands. If a player has placed a bonus side bet and has achieved a bonus hand, he or she receives a bonus payout regardless of if the hand beats the dealer's hand.

Players are able to play up to a maximum of two total hands per game. A player who wishes to play more than one hand is required to double his or her minimum bet. The player may only play an additional hand that is dealt to an unoccupied player position to his or her immediate left or right.

The present invention provides the advantage of providing much higher rates of royal flushes than ordinary games of poker by eliminating deuces through nines from the playing deck.

### BRIEF DESCRIPTION OF THE DRAWINGS

FIG. 1 is a system diagram of the present invention.

FIG. 2 is a flowchart describing the general process of the present invention.

FIG. 3 is a flowchart describing the steps of managing the virtual deck.

FIG. 4 is a flowchart describing the steps of receiving monetary deposits through the provided player terminals.

FIG. 5 is a flowchart describing the steps of dispensing monetary withdrawals through the provided player terminals.

FIG. 6 is a flowchart describing the steps of receiving a monetary ante funded by a corresponding player bank.

FIG. 7 is a flowchart describing the steps of displaying a dealer hand through a dealer terminal.

FIG. 8 is a flowchart describing the steps of displaying the corresponding player hand through each of the active terminals.

FIG. 9 is a flowchart describing the steps of receiving a fold request.

FIG. 10 is a flowchart describing the steps of receiving a playing bet request.

FIG. 11 is a flowchart describing the steps of calculating and awarding the monetary payout.

FIG. 12 is a flowchart describing the steps of increasing payout ratios to create rising jackpots.

FIG. 13 is a flowchart describing the steps of receiving a side bet.

FIG. 14 is a flowchart describing the steps of calculating the monetary payout for a winning terminal with an envy status.

FIG. 15 is a flowchart describing the steps of awarding an envy payout.

FIG. 16 is a flowchart describing the steps returning the monetary ante bet and the bet amount of the playing bet request to the corresponding player bank of a tying terminal.

FIG. 17 is a flowchart describing the steps forfeiting the monetary ante and the bet amount for the playing bet request for a losing terminal.

FIG. 18 is a diagram showing the preferred embodiment of the electronic game table.

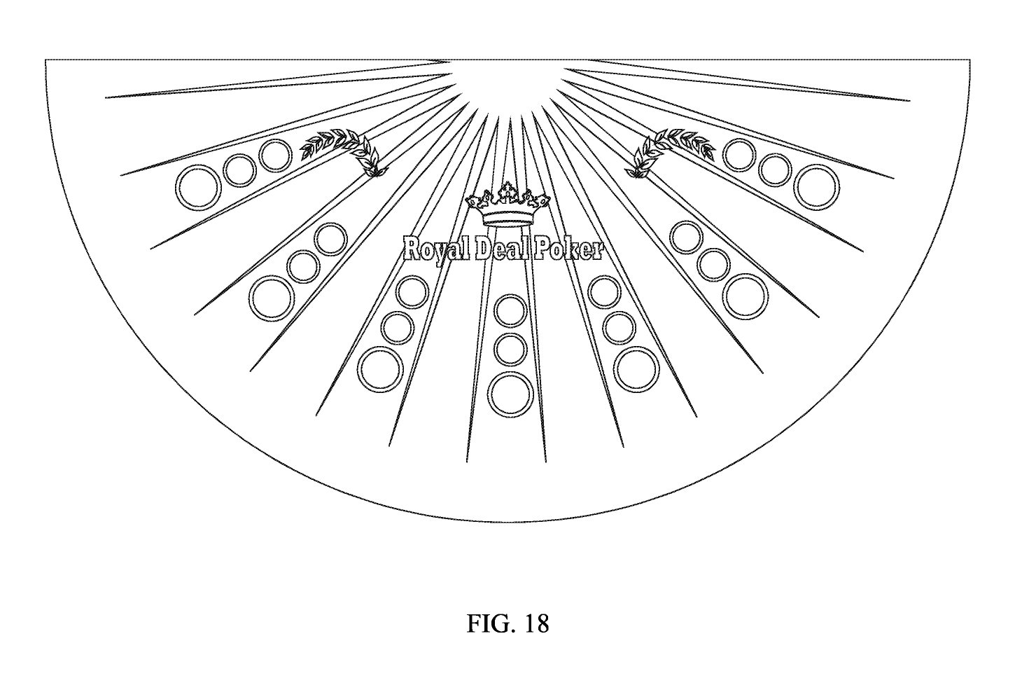

### DETAILED DESCRIPTION OF THE INVENTION

All illustrations of the drawings are for the purpose of describing selected versions of the present invention and are not intended to limit the scope of the present invention.

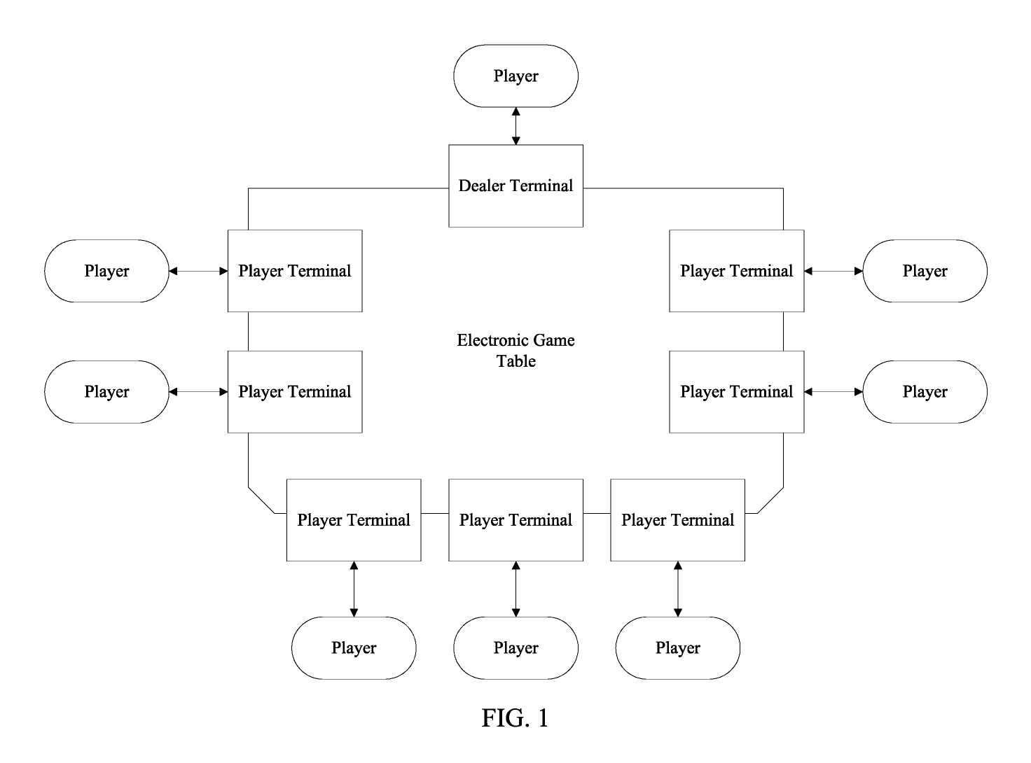

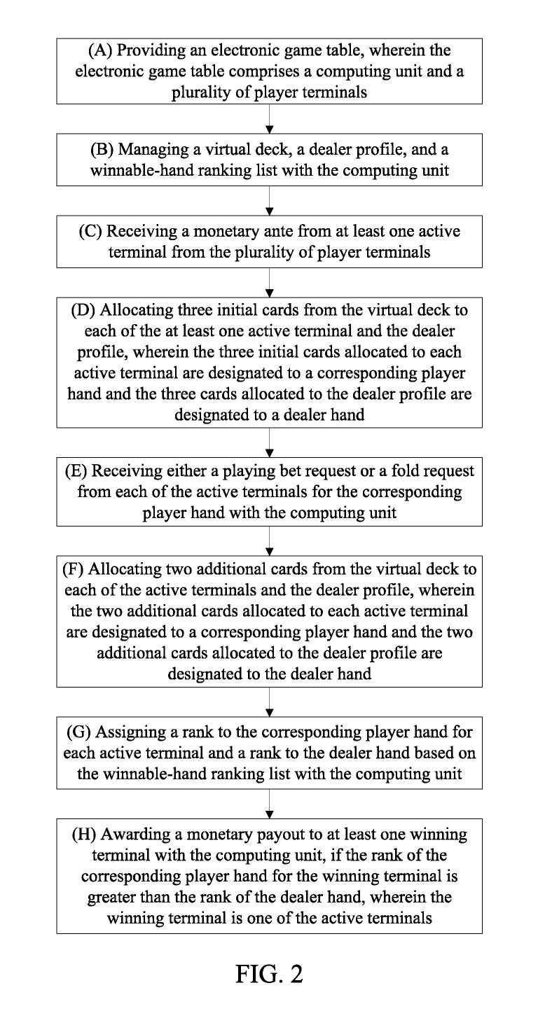

With reference to FIGS. 1-2, the present invention is a method of managing a card game through player terminals. In the preferred embodiment of the present invention, the method is performed by an electronic game table that comprises a computing unit and a plurality of player terminals (Step A). Like a traditional game table, the electronic game table is used to play a card game. However, instead of physical cards, the game is played virtually and is managed by the computing unit, which acts as the administrative hub to receive inputs, process commands, and generate outputs for all actions executed during the card game. Each of the player terminals allows multiple people to play the game and includes input/output devices such as a touchscreen, a physical control panel with press buttons, or a keyboard-mouse combination that enables a person to interact with the computing unit. A virtual deck, a dealer profile, and a winnable-hand ranking list are managed by the computing unit (Step B). Like a physical deck, the cards from the virtual deck are dealt to players while playing the card game. Cards are also dealt to the dealer profile. When playing the card game, players using player terminals aim to beat the hand dealt to the dealer profile. The winnable-hand ranking list is used to determine if a player possesses a hand that is better than the hand possessed by the dealer profile.

To begin a round of the card game, the computing unit must receive a monetary ante from at least one active terminal from the plurality of player terminals (Step C). The monetary ante is used to buy a player into the card game. An active terminal is one of the player terminals that is active and is being used by a person to play the card game. After the monetary ante is received from each of the at least one active terminal, cards may be dealt. Three initial cards from the virtual deck are allocated to each of the at least one active terminal and to the dealer profile (Step D). The three initial cards allocated to each active terminal are designated to a corresponding player hand and the three initial cards allocated to the dealer profile are designated to a dealer hand. At the end of each round of the card game, each of the corresponding player hands are compared with the dealer hand to determine if any of the active terminals win the round. After dealing the initial cards, the computing unit receives either a playing bet request or a fold request from each of the active terminals for the corresponding player hand (Step E). In order to remain in the round, each active terminal is required to place a playing bet request. Otherwise, an active terminal can place a fold request and sit out until the next round.

After each active terminal has either placed a playing bet request or a fold request, two additional cards from the virtual deck are allocated to each of the active terminals and the dealer profile (Step F). The two additional cards allocated to each active terminal are designated to the corresponding player hand and the two additional cards allocated to the dealer profile are designated to the dealer hand. At this point, no additional cards are dealt and winning hands may be determined. To do so, a rank is assigned to the corresponding player hand for each active terminal based on the winning-hand ranking list by the computing unit, and a rank is assigned to the dealer hand based on the winning-hand ranking list by the computing unit (Step G). The computing unit is then awards a monetary payout to at least one winning terminal if the rank of the corresponding player hand for the winning terminal is greater than the rank of the dealer hand, wherein the winning terminal is one of the active terminals (Step H). In the preferred embodiment of the present invention, the monetary payout is proportional to how much is bet by the winning terminal.

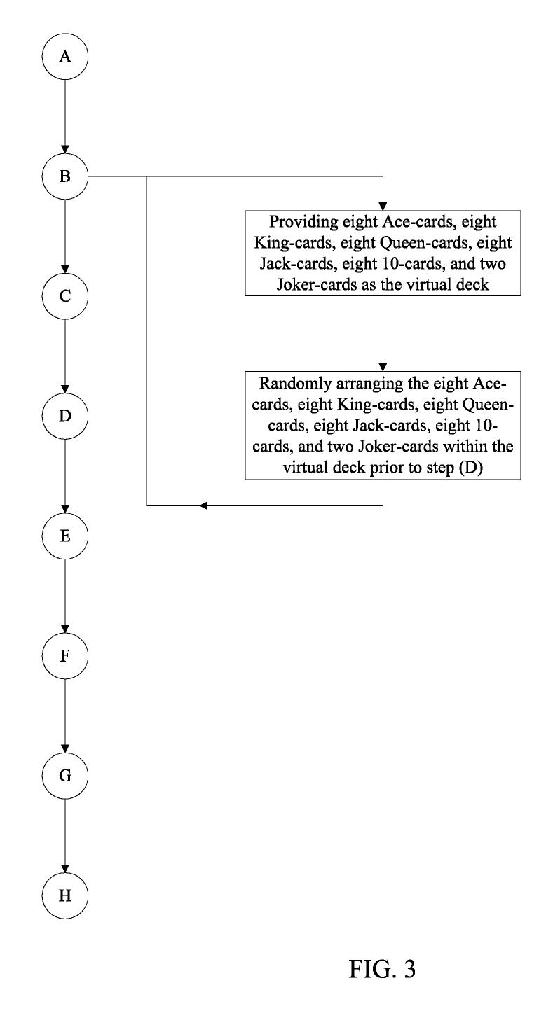

In reference to FIG. 3, the virtual deck comprises eight Ace-cards, eight King-cards, eight Queen-cards, eight Jack-cards, eight 10-cards, and two Joker-cards. Throughout the course of a round, the dealer profile and each player terminal have the potential to be dealt a total of five cards. Since the virtual deck comprises a total of forty-two cards, the preferred embodiment of the electronic game table comprises seven player terminals in order to maximize the potential number of players without potentially requiring more cards than are in the virtual deck. Before each round of the card game, the eight Ace-cards, eight King-cards, eight Queen-cards, eight Jack-cards, eight 10-cards, and two Joker-cards are randomly arranged within the virtual deck prior to step D. This is done to ensure that each player is given a fair chance at winning the card game.

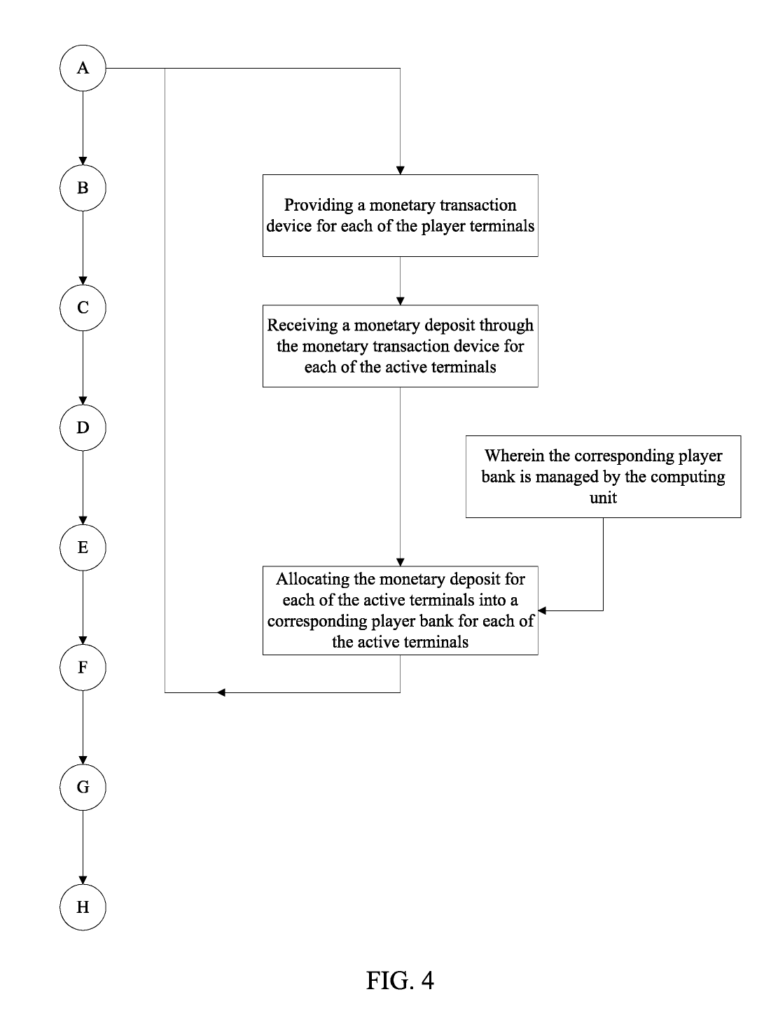

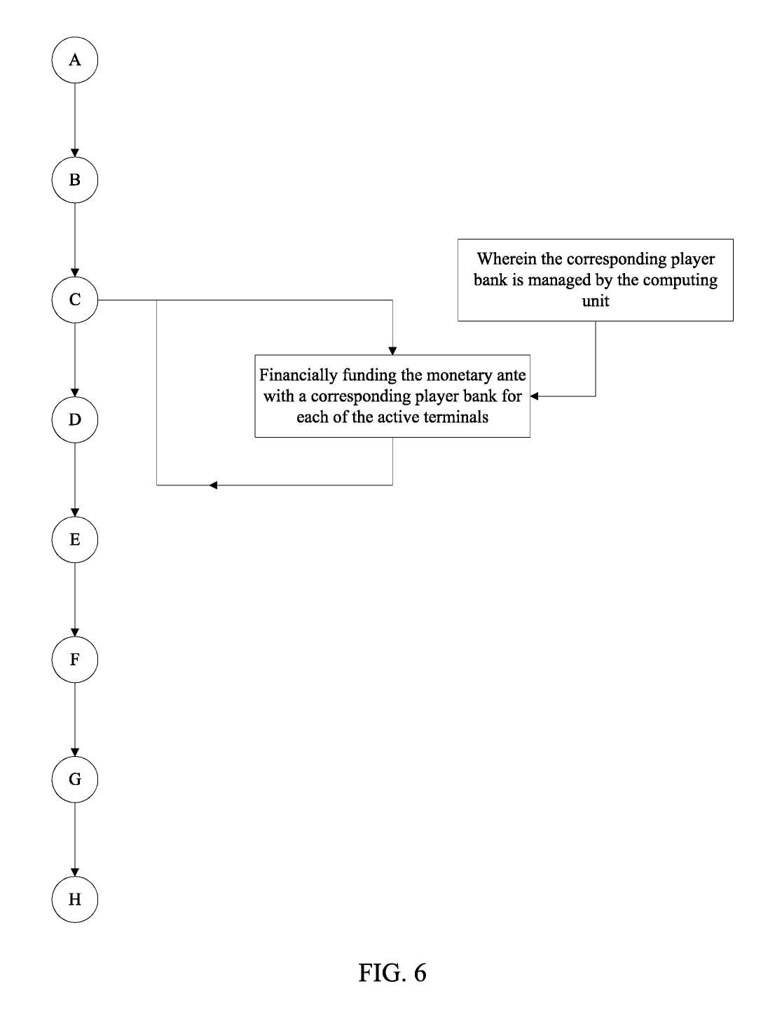

In reference to FIG. 4 and FIG. 6, each of the player terminals comprises a monetary transaction device. The monetary transaction device is used to deposit money into the electronic gaming table or withdraw money from the electronic gaming table. In order to fund active terminals, a monetary deposit is received through the monetary transaction device for each of the active terminals. The monetary transaction device is capable of receiving the monetary deposit as cash, credit card, debit card, casino voucher, or other means of transferring monetary funds. The monetary deposit for each of the active terminals is allocated into a corresponding player bank for each of the active terminals. The corresponding player bank is managed by the computing unit and is used to financially fund one or more monetary antes, playing bets, or side bets. Furthermore, any money won by playing the card game is stored within the corresponding player bank until the player wishes to make a withdrawal.

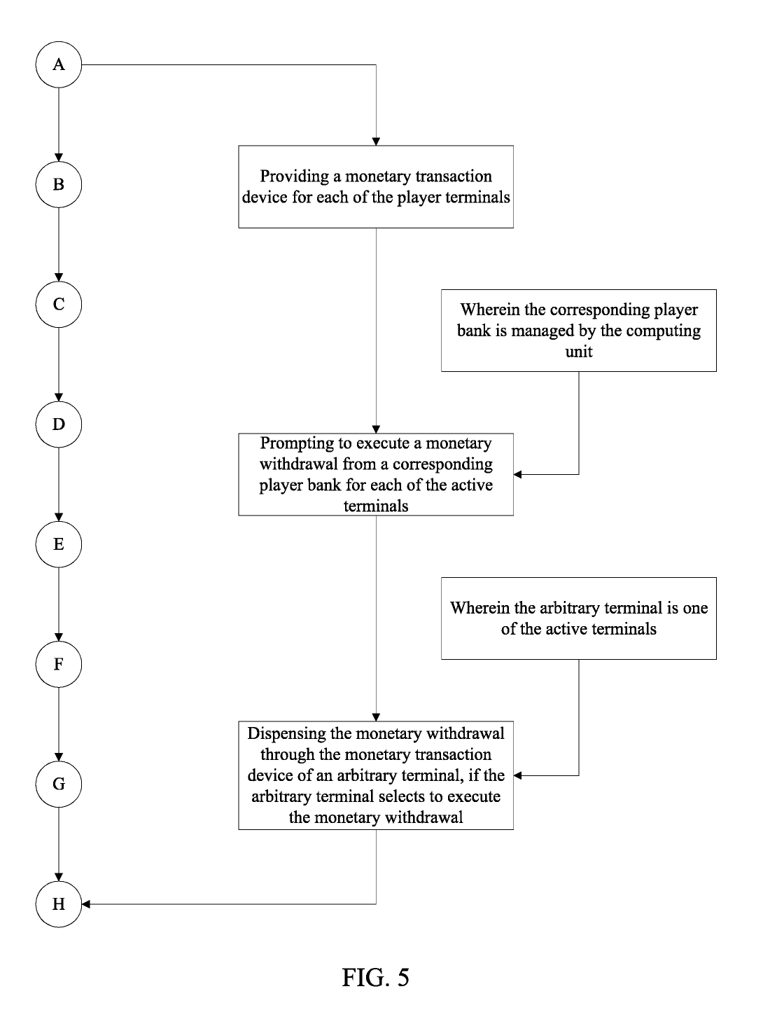

In reference to FIG. 5, when cashing out of a player terminal, players are prompted to execute a monetary withdrawal from the corresponding player bank for each of the active terminals. The monetary transaction device is capable of outputting the monetary deposit as cash, casino voucher, or other means of transferring monetary funds. Typically, the monetary withdrawal accounts for the entire corresponding player bank, however, smaller denominations may alternatively be withdrawn. The monetary withdrawal is dispensed through the monetary transaction device of an arbitrary terminal, if the arbitrary terminal selects to execute the monetary withdrawal. The arbitrary terminal may be any one of the active terminals. If the player controlling the arbitrary terminal completely cashes out and leaves the arbitrary terminal, another player will need to make a monetary deposit and place a monetary ante in order to participate in the next round.

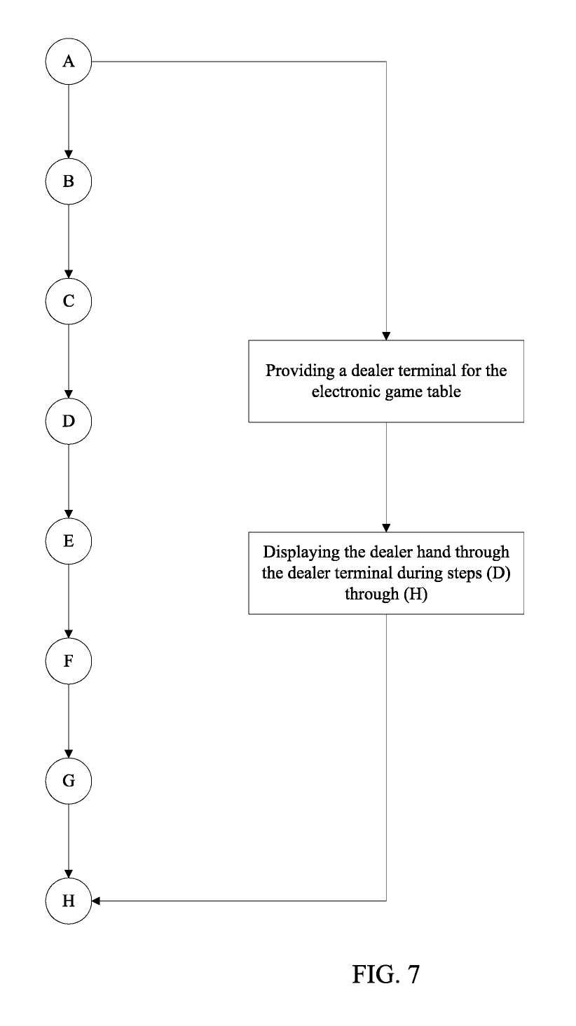

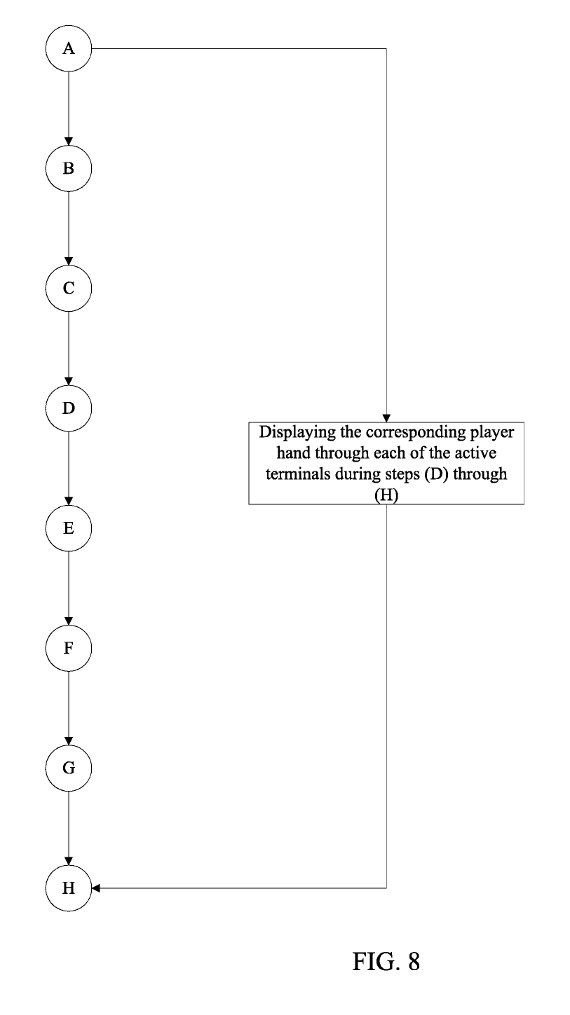

In reference to FIGS. 7-8, the electronic game table comprises a dealer terminal. The dealer terminal allows a dealer to be present and monitor each round of the card game. Similar to a player terminal, the dealer terminal includes input/output devices such as a touchscreen, a physical control panel with press buttons, or a keyboard-mouse combination that enables a person to interact with the computing unit. The dealer hand is displayed through the dealer terminal during steps D through H. Further, the dealer terminal may be used to allow the dealer to control the progression of steps D through H. Likewise, the corresponding player hand is displayed through each of the active terminals during steps D through H. This allows players to view the corresponding player hand and bet or fold accordingly.

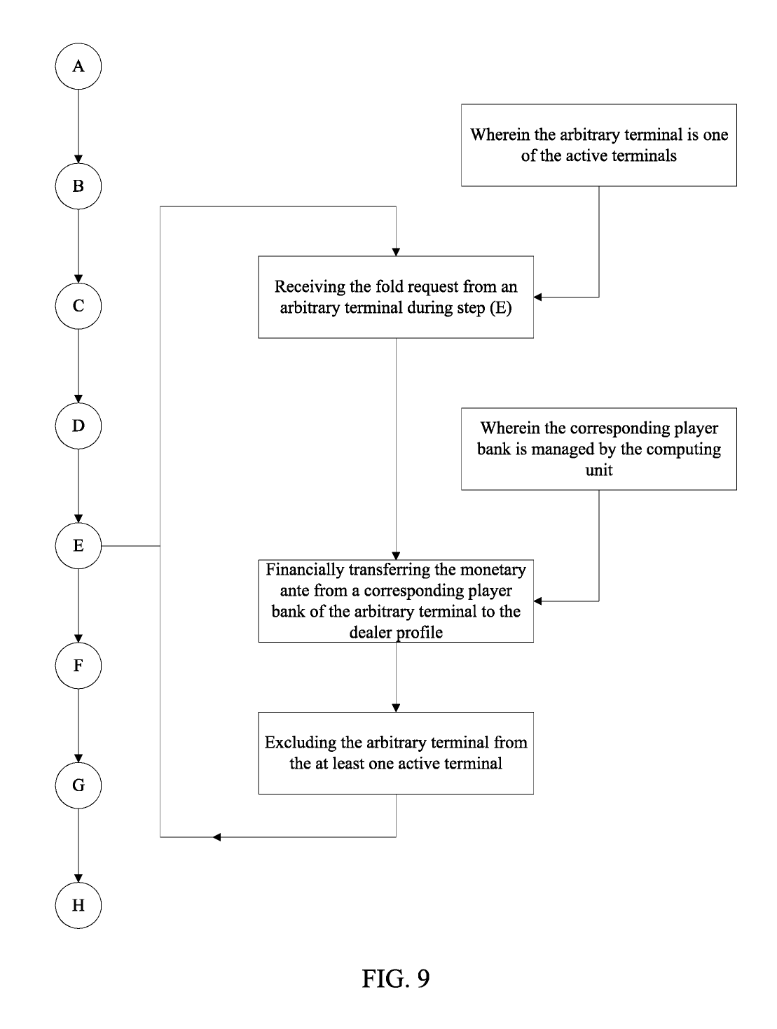

Because a player may wish to not complete a round based on receiving unfavorable initial cards, players have the option to fold instead of continuing the round with a playing bet. In this situation, instead of receiving the playing bet, the fold request is received from an arbitrary terminal during step E. In reference to FIG. 9, the arbitrary terminal can be any one of active terminals. If all of the active terminals choose to place a fold request, the dealer profile wins the round by default. By choosing to fold, the player is forfeiting their monetary ante along with the opportunity to win the round. When a fold request is placed, the monetary ante is financially transferred from a corresponding player bank of the arbitrary terminal to the dealer profile. Further, the arbitrary terminal is excluded from the at least one active terminal. As previously mentioned, if no active terminals remain, the round ends. Otherwise, the active terminals that placed playing bet requests are permitted to continue the round.

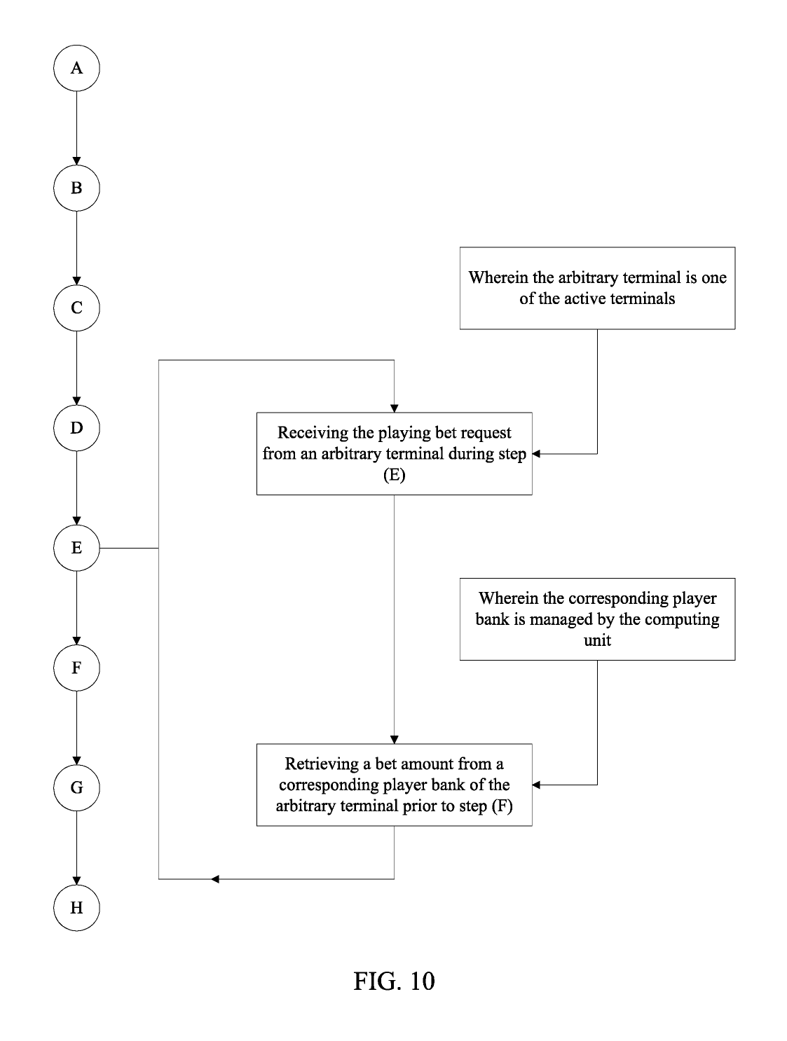

In reference to FIG. 10, for the active terminals that place a playing bet request, the playing bet request is received from an arbitrary terminal during step E. A bet amount is retrieved from a corresponding player bank of the arbitrary terminal prior to step F. Depending on the rules set by the house, minimum or maximum bet amounts may be set. The bet amount is used to determine the monetary payout if the arbitrary terminal is one of the winning terminals.

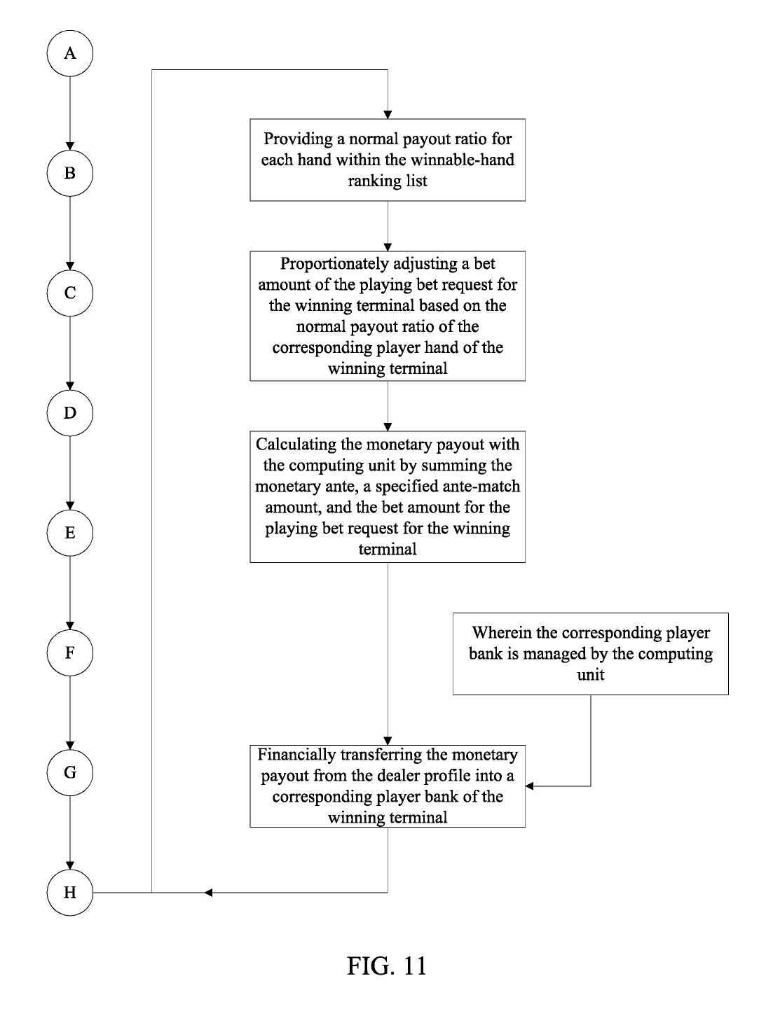

In reference to FIG. 11, a normal payout ratio is provided for each hand within the winnable-hand ranking list. The normal payout ratio is used for active terminals that do not place a side bet. The normal payout ratio generally follows an inverse relationship with the odds of receiving any given hand within the winnable-hand ranking list. The highest payout ratios are attributed to the hands which are the most difficult to obtain. The bet amount for the winning terminal is proportionally adjusted based on the normal payout ratio of the corresponding player hand of the winning terminal. As a result, playing bet requests that are of a higher bet amount have the potential to yield a higher monetary payout. The same is true for corresponding player hands that are difficult to obtain. The monetary payout is calculated with the computing unit by summing the monetary ante, a specified ante-match amount, and the bet amount of the playing bet request for the winning terminal. The monetary ante does not get multiplied with the normal payout ratio. Instead, the winning terminal is refunded the monetary ante and given the specified ante-match amount as part of the monetary payout. In the preferred embodiment of the present invention, the specified ante-match amount is equal to the monetary ante; however, the specified ante-match amount may vary depending on house rules. The monetary payout is financially transferred into a corresponding player bank of the winning terminal. At this point, the player may choose to make a monetary withdrawal or continue playing.

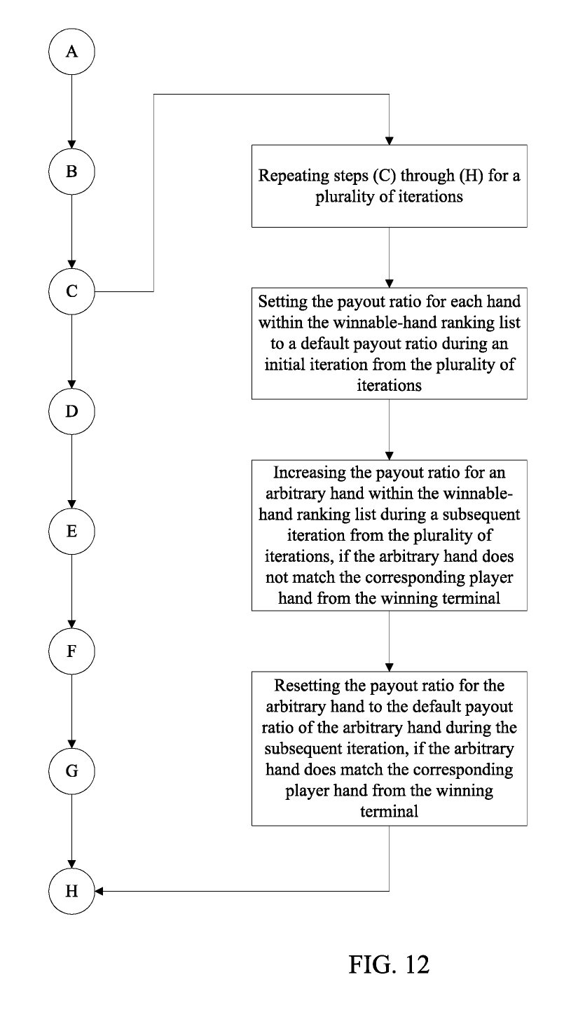

In reference to FIG. 12 because the present invention is intended to work for multiple rounds of the card game, steps C through H are repeated for a plurality of iterations. Throughout the plurality of iterations, the present invention may incorporate the idea of a rising jackpot for hands that are not obtained often. To start, the payout ratio for each hand within the winnable-hand ranking list is set to a default payout ratio during an initial iteration from the plurality of iterations. At the end of a round, the payout ratio for an arbitrary hand within the winnable-hand ranking list is increased during a subsequent iteration from the plurality of iterations, if the arbitrary hand does not match the corresponding player hand from the winning terminal(s). Alternatively, if the arbitrary hand does not match the corresponding player hand from the winning terminal, the payout ratio for the arbitrary hand is reset to the default payout ratio of the arbitrary hand during the subsequent iteration. While this method works on a round-by-round basis, payout ratios may alternatively be increased or decreased based on the results of a group of iterations rather than a single iteration.

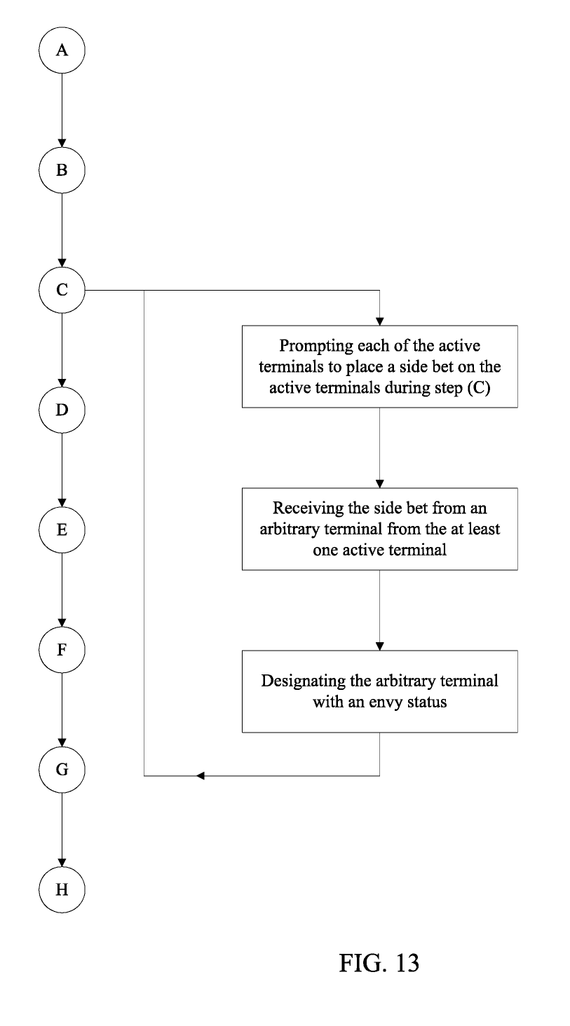

In addition to a playing bet request, each of the active terminals is prompted to place a side bet on the active terminals during step C. In reference to FIG. 13, if a player chooses to make a side bet, the side bet is received from an arbitrary terminal from the at least one active terminal, and the arbitrary terminal is designated with an envy status. The side bet allows players to bet on the potential outcome where one or more of the active terminals, other than the arbitrary terminal, has a winning envy hand. Further, the side bet allows players to raise the stakes on the playing bet request.

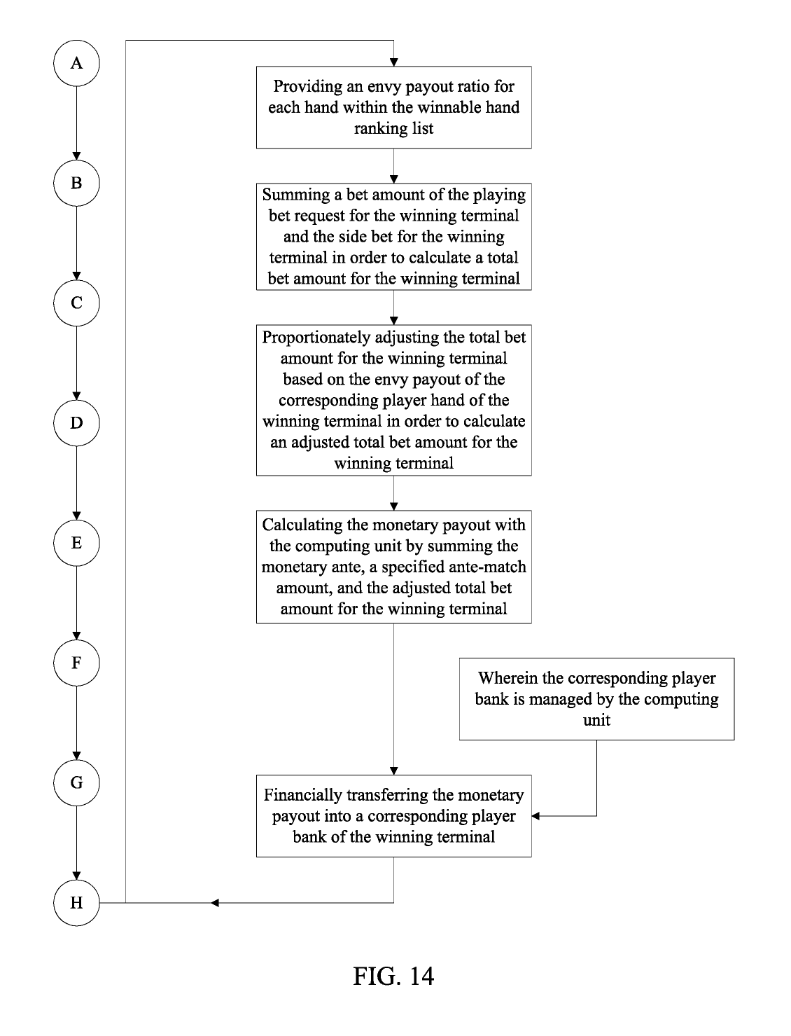

In reference to FIG. 14, awarding the monetary payout works differently if the winning terminal placed a side bet. In order to calculate the monetary payout, an envy payout ratio is provided for each hand within the winnable-hand ranking list. For active terminals with an envy status, the envy payout ratios are used instead of normal payout ratios. The difference between the two is that that the envy payout ratios are larger but apply to a smaller amount of potential hands. The bet amount of the playing bet request for the winning terminal and the side bet for the winning terminal are summed in order to calculate a total bet amount for the winning terminal. The total bet amount for the winning terminal is proportionately adjusted based on the envy payout ratio of the corresponding player hand of the winning terminal in order to calculate an adjusted total bet amount for the winning terminal. As a result, the adjusted total bet amount factors in the envy payout ratio and accounts for the majority of the monetary payout. The monetary payout is calculated with the computing unit by summing the monetary ante, the specified ante-match amount, and the adjusted total bet amount for the winning terminal. Similar to the monetary payout without the side bet, the use of a side bet does not affect the monetary ante. The monetary ante is returned to the winning terminal, along with the specified ante-match amount. The monetary payout is financially transferred into the corresponding player bank of the winning terminal. The player may then choose to make a monetary withdrawal or continue playing.

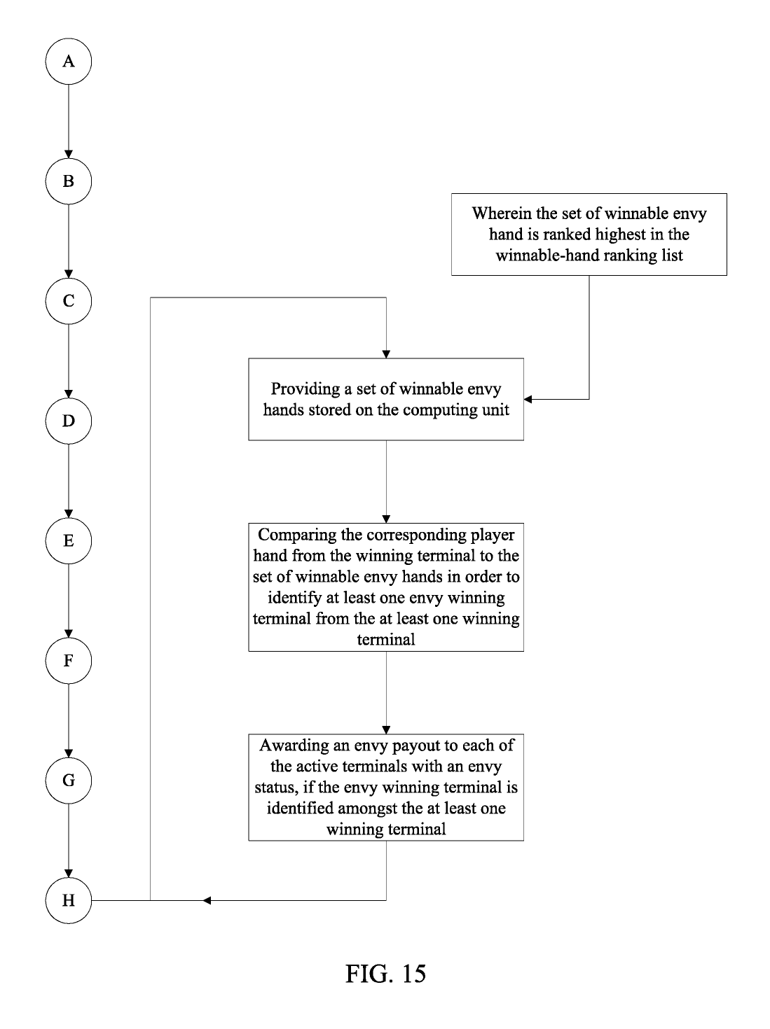

In reference to FIG. 15, active terminals with an envy status also have an opportunity to win money based on the success of other active terminals. A set of winnable envy hands is stored on the computing unit and is ranked highest in the winnable-hand ranking list. Such hands can include, but are not limited to, a natural royal flush, natural five aces, and wild five aces. To detect a winning envy hand, the corresponding player hand from the winning terminal is compared to the set of winnable envy hands in order to identify at least one envy winning terminal from the at least one winning terminal. An envy payout is awarded to each of the active terminals with an envy status, if the envy wining terminal is identified amongst the at least one winning terminal. In the preferred embodiment of the present invention, the envy payout is a flat rate for each winning envy hand and does not depend on the size of the side bet.

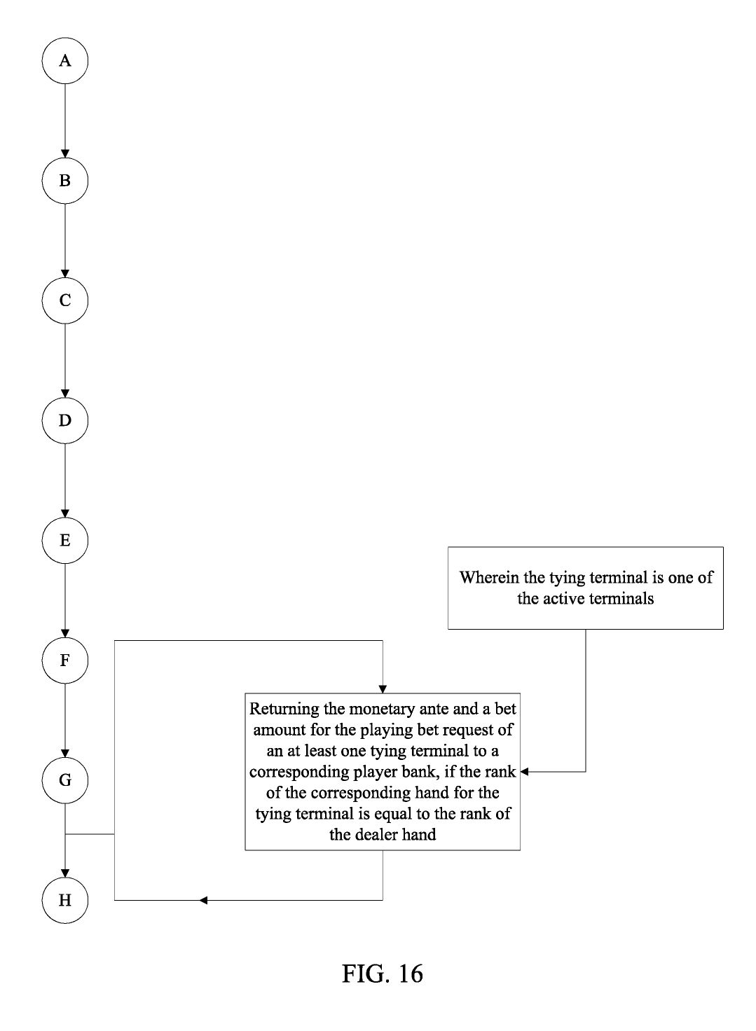

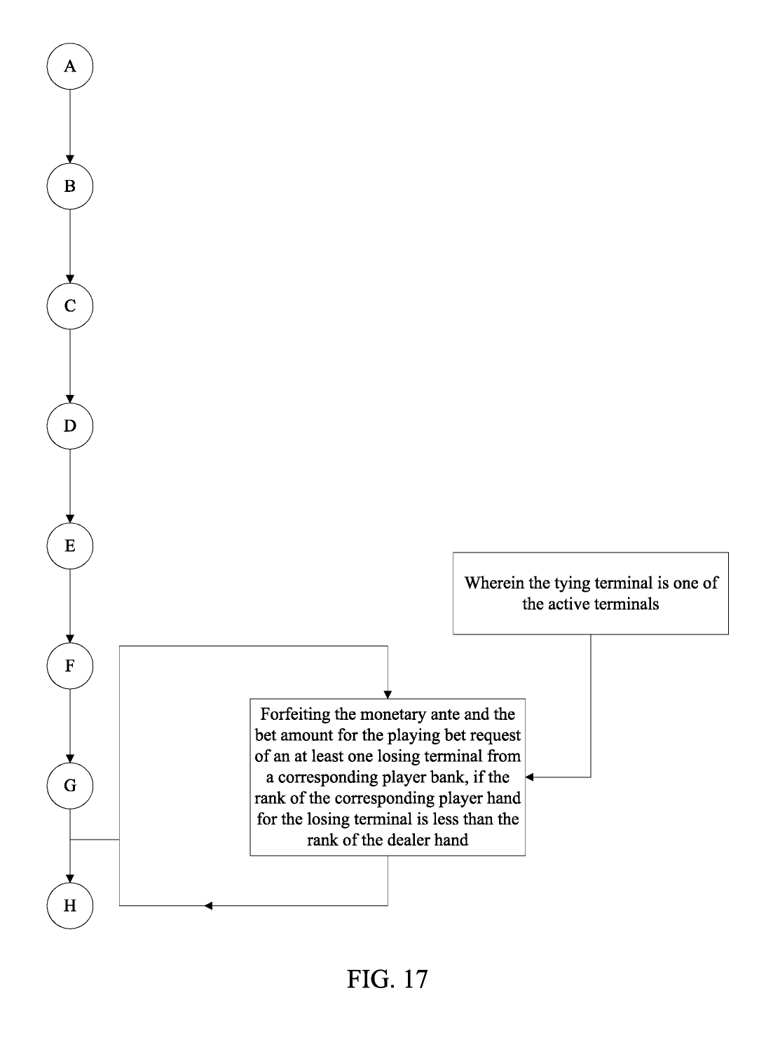

In reference to FIGS. 16-17, an active terminal is determined to be a tying terminal if the rank of the corresponding player hand for the tying terminal is equal to the rank of the dealer hand. When this happens, the monetary ante and the bet amount for the playing bet request of the tying terminal are returned to the corresponding player bank. The playing bet may also be returned to the corresponding player bank if the corresponding player hand does not rank high enough on the winnable-hand ranking list. This occurs even though the corresponding player hand is ranked higher than the dealer hand. Similarly, an active terminal is determined to be a losing terminal if the rank of the corresponding player hand is less than the rank of the dealer hand. When this happens, the monetary ante and the bet amount for the playing bet request of the losing terminal are forfeited from the corresponding player bank.

Although the invention has been explained in relation to its preferred embodiment, it is to be understood that many other possible modifications and variations can be made without departing from the spirit and scope of the invention as hereinafter claimed.

What is claimed is:

1. A method of managing a card game through player terminals, the method comprises the steps of:
(A) providing an electronic game table, wherein the electronic game table comprises a computing unit and a plurality of player terminals;
(B) managing a virtual deck, a dealer profile, and a winnable-hand ranking list with the computing unit;
(C) receiving a monetary ante from at least one active terminal from the plurality of player terminals;
(D) allocating three initial cards from the virtual deck to each of the at least one active terminal and the dealer profile, wherein the three initial cards allocated to each active terminal are designated to a corresponding player hand and the three initial cards allocated to the dealer profile are designated to a dealer hand;
(E) receiving either a playing bet request or a fold request from each of the active terminals for the corresponding player hand with the computing unit;
(F) allocating two additional cards from the virtual deck to each of the active terminals and the dealer profile, wherein the two additional cards allocated to each active terminal are designated to the corresponding player hand and the two additional cards allocated to the dealer profile are designated to the dealer hand;
(G) assigning a rank to the corresponding player hand for each active terminal and a rank to the dealer hand based on the winnable-hand ranking list with the computing unit; and
(H) awarding a monetary payout to at least one winning terminal with the computing unit, if the rank of the corresponding player hand for the winning terminal is greater than the rank of the dealer hand, wherein the winning terminal is one of the active terminals.

2. The method of managing a card game through player terminals as claimed in claim 1 comprises:
providing eight Ace-cards, eight King-cards, eight Queen-cards, eight Jack-cards, eight 10-cards, and two Joker-cards as the virtual deck; and
randomly arranging the eight Ace-cards, the eight King-cards, the eight Queen-cards, the eight Jack-cards, the eight 10-cards, and the two Joker-cards within the virtual deck prior to step (D).

3. The method of managing a card game through player terminals as claimed in claim 1 comprises:
providing a monetary transaction device for each of the player terminals;
receiving a monetary deposit through the monetary transaction device for each of the active terminals; and
allocating the monetary deposit for each of the active terminals into a corresponding player bank for each of the active terminals, wherein the corresponding player bank is managed by the computing unit.

4. The method of managing a card game through player terminals as claimed in claim 1 comprises:
providing a monetary transaction device for each of the player terminals;
prompting to execute a monetary withdrawal from a corresponding player bank for each of the active terminals, wherein the corresponding player bank is managed by the computing unit; and
dispensing the monetary withdrawal through the monetary transaction device of an arbitrary terminal,
if the arbitrary terminal selects to execute the monetary withdrawal,
wherein the arbitrary terminal is one of the active terminals.

5. The method of managing a card game through player terminals as claimed in claim 1 comprises:
financially funding the monetary ante with a corresponding player bank for each of the active terminals, wherein the corresponding player bank is managed by the computing unit.

6. The method of managing a card game through player terminals as claimed in claim 1 comprises:
providing a dealer terminal for the electronic game table; and
displaying the dealer hand through the dealer terminal during steps (D) through (H).

7. The method of managing a card game through player terminals as claimed in claim 1 comprises:
displaying the corresponding player hand through each of the active terminals during steps (D) through (H).

8. The method of managing a card game through player terminals as claimed in claim 1 comprises:
receiving the fold request from an arbitrary terminal during step (E), wherein the arbitrary terminal is one of the active terminals;
financially transferring the monetary ante from a corresponding player bank of the arbitrary terminal to the dealer profile, wherein the corresponding player bank is managed by the computing unit; and
excluding the arbitrary terminal from the at least one active terminal.

9. The method of managing a card game through player terminals as claimed in claim 1 comprises:
receiving the playing bet request from an arbitrary terminal during step (E), wherein the arbitrary terminal is one of the at least one active terminals; and
retrieving a bet amount from a corresponding player bank of the arbitrary terminal prior to step (F), wherein the corresponding player bank is managed by the computing unit.

10. The method of managing a card game through player terminals as claimed in claim 1 comprises:
providing a normal payout ratio for each hand within the winnable-hand ranking list;
proportionately adjusting a bet amount of the playing bet request for the winning terminal based on the normal payout ratio of the corresponding player hand of the winning terminal;
calculating the monetary payout with the computing unit by summing the monetary ante, a specified ante-match amount, and the bet amount for the playing bet request for the winning terminal; and
financially transferring the monetary payout into a corresponding player bank of the winning terminal, wherein the corresponding player bank is managed by the computing unit.

11. The method of managing a card game through player terminals as claimed in claim 10 comprises:
repeating steps (C) through (H) for a plurality of iterations;
setting the payout ratio for each hand within the winnable-hand ranking list to a default payout ratio during an initial iteration from the plurality of iterations;
increasing the payout ratio for an arbitrary hand within the winnable-hand ranking list during a subsequent iteration from the plurality of iterations,
if the arbitrary hand does not match the corresponding player hand from the winning terminal; and
resetting the payout ratio for the arbitrary hand to the default payout ratio of the arbitrary hand during the subsequent iteration,
if the arbitrary hand does match the corresponding player hand from the winning terminal.

12. The method of managing a card game through player terminals as claimed in claim 1 comprises:
prompting each of the active terminals to place a side bet on the active terminals during step (C);
receiving the side bet from an arbitrary terminal from the at least one active terminal; and
designating the arbitrary terminal with an envy status.

13. The method of managing a card game through player terminals as claimed in claim 12 comprises:
providing an envy payout ratio for each hand within the winnable-hand ranking list;
summing a bet amount of the playing bet request for the winning terminal and the side bet for the winning terminal in order to calculate a total bet amount for the winning terminal;
proportionately adjusting the total bet amount for the winning terminal based on the envy payout ratio of the corresponding player hand of the winning terminal in order to calculate an adjusted total bet amount for the winning terminal;
calculating the monetary payout with the computing unit by summing the monetary ante, a specified ante-match amount, and the adjusted total bet amount for the winning terminal; and
financially transferring the monetary payout into a corresponding player bank of the winning terminal, wherein the corresponding player bank is managed by the computing unit.

14. The method of managing a card game through player terminals as claimed in claim 1 comprises:
providing a set of winnable envy hands stored on the computing unit, wherein the set of winnable envy hands is ranked highest in the winnable-hand ranking list;
comparing the corresponding player hand from the winning terminal to the set of winnable envy hands in order to identify at least one envy winning terminal from the at least one winning terminal; and
awarding an envy payout to each of the active terminals with an envy status,
if the envy winning terminal is identified amongst the at least one winning terminal.

15. The method of managing a card game through player terminals as claimed in claim 1 comprises:
returning the monetary ante and a bet amount for the playing bet request of an at least one tying terminal to a corresponding player bank, if the rank of the corresponding player hand for the tying terminal is equal to the rank of the dealer hand, wherein the tying terminal is one of the active terminals.

16. The method of managing a card game through player terminals as claimed in claim 1 comprises:
forfeiting the monetary ante and the bet amount for the playing bet request of an at least one losing terminal from a corresponding player bank, if the rank of the corresponding player hand for the losing terminal is less than the rank of the dealer hand, wherein the losing terminal is one of the active terminals.
